(19) United States
(12) Patent Application Publication
(10) Pub. No.: US 2017/0341856 A1
(43) Pub. Date: Nov. 30, 2017

(54) BEVERAGE CAPSULE, BEVERAGE PREPARATION SYSTEM AND METHOD FOR IDENTIFYING A BEVERAGE CAPSULE

(71) Applicant: Qbo Coffee GmbH, Wallisellen (CH)

(72) Inventor: Ivo Aschwanden, Zürich (CH)

(21) Appl. No.: 15/534,099

(22) PCT Filed: Dec. 8, 2015
(86) PCT No.: PCT/EP2015/078939

§ 371 Date: Jun. 8, 2017

(30) Foreign Application Priority Data
Dec. 11, 2014 (EP) 14197488.1

(51) Int. Cl. B65D 85/804; A47J 31/40; A47J 31/44; B65D 79/00

(52) U.S. Cl. CPC B65D 85/8043; B65D 79/00; A47J 31/407; A47J 31/4492

(57) ABSTRACT

A capsule for beverage preparations in a brewing machine, the capsule including a capsule container that is filled with an extraction product and has an essentially quadratic base, and a capsule cover that closes the capsule container. The capsule has at least one first optically readable code on the base of the capsule container, the code having a two-dimensional arrangement of several code elements, the first code being subdivided into a regular imaginary arrangement of code fields that are regrouped into at least pairs to form code groups, only one individual code field being provided within a code group with a code element. The invention also relates to a capsule and to an associated system including a brewing machine and to a method for identifying the type of capsule.

### BACKGROUND OF THE INVENTION

### Field of the Invention

The present invention relates to a drinks (beverage) capsule for creating a drink (beverage) from a drinks ingredient contained in the capsule. In particular, it relates to a drinks capsule that includes a code, the code able to contain information on the drinks ingredient contained in the capsule or on other characteristics of the capsule, and being able to be decoded by a brewing machine. The invention moreover relates to a drinks (beverage) preparation system including a drinks capsule and a brewing machine, and to a method for identifying a drinks capsule in a brewing machine.

### Description of Related Art

Specifically, the present invention relates to a capsule for drinks preparation in a brewing machine, the capsule including a capsule beaker filled with a drinks ingredient and having an essentially square base, and a capsule cover which is fastened on the capsule beaker. The capsule as a whole is thereby preferably essentially cubic, i.e. the lateral walls of the capsule, which connect the base and the cover, have essentially the same square shape as the base and the cover. The lateral edge length however can also be larger or smaller, so that an essentially cuboid capsule then arises.

Capsules of this type are known from EP 2419352 A1, WO 2015/096989, WO 2105/096990 and WO 2015/096991, which are referred to here.

Individual portion capsules for preparing drinks, in particular hot drinks (beverages) such as coffee, tea, chocolate drinks or milks drinks are enjoying increasing popularity. Such drinks capsules typically include an extraction material, such as roasted or ground coffee or tea, for example, or one or more soluble drinks ingredients such as instant coffee, milk powder or cocoa powder. Apart from these known ingredients, the term “extraction material” within the scope of the present invention is also to include a cleaning agent, which can be utilised for cleaning a brewing machine.

It is already known to provide drinks capsules with a code, which can be read out by the brewing machine and which, for example, contains information on the capsule type, on the drinks ingredient or on the optimal brewing parameters for the capsule concerned. Capsules, on which a bar code is deposited on a cover membrane, amongst others are known, for example, from EP 2168073, and capsules, on which a QR-code is printed, likewise on a cover membrane, are known from WO 2011/089048A1 for example.

It is indeed relatively simple to deposit a code on a cover membrane, which is to say on a capsule cover. The covers are often printed in any case and can be provided with a code with only little additionally effort. However, the reading-out of the code on the cover is difficult, particularly given a horizontal arrangement of the capsule in a brewing machine, with which the water is mostly introduced through the capsule base, and the brewed product exits through the cover membrane which is to say through the cover and is led into the cup. A detection unit, which is provided in the brewing chamber at the side of the capsule cover, is therefore always exposed to a contamination by way of drinks residues, splashes, etc. Moreover, one typically wishes to keep the path between the exit of the drink out of the capsule and the cup as short as possible, and for this reason it is quite a challenge to be able to accommodate the detection unit at all. The solutions, which are described in EP 2168073 and in WO 2011/089048A1, are therefore not suitable for capsules, which are brewed in so-called horizontal brewing machines, i.e. in a horizontal alignment.

Further disadvantages of the state of the art lie in the applied codes themselves. The quantity and type of information which can be coded into a bar code is very limited.

QR-codes and similar, known 2-D codes, although being able to contain and code very much more information, however due to their structure are only suitable for the application on drinks capsules to a limited extent, if these are to be read out in brewing machines. A common problem on reading out a code provided on a capsule, in a brewing machine, are specifically the contaminations which arise due to splashing of drinks, lime deposits and the like, and such contamination can occur on the read-out optics, as well as on the capsule itself, depending on the mounting of the capsules.

Common, optical 2-D codes include all so-called finder patterns, whose successful recognition is absolutely necessary, in order to be able to read out the code. If a local contamination is now located right in the region of the finder pattern, then the complete code becomes unreadable. This then leads to an error notice, depending on the programming of the machine, and this demands a removal of the non-readable capsule. If such a problem cannot be overcome by way of cleaning the read-out optics or the capsule, then the capsule-which per se is consumable-must possibly even be thrown away, which is of course not acceptable from the customer's point of view. The demands upon the optics of the camera and on the computation capability of the processor of the detection unit in a brewing machine are difficult to meet with an acceptable effort with regard to cost and space, in the case of the known 2-D codes.

### SUMMARY OF THE INVENTION

It is therefore an object of the present invention, to provide a capsule of the initially mentioned type, which is provided with a code, the code being able to store a sufficient quantity of information and being able to be read out in the brewing machine in a rapid manner and with an extremely high success rate. It is further an object of the invention, to provide a system of such a capsule and of a brewing machine, as well as a method for the identification of such a capsule, which overcome the mentioned disadvantages.

According to the invention, at least one first optically readable code, which is to say one that is visually and directly recognisable in the visible region and/or, for example, in the infrared region or possibly ultra-violet region, by way of suitable aids (camera with a sensor sensitivity in the infrared region or the like), is provided on the base of the capsule beaker. This code includes a two-dimensional arrangement of several first code elements. The first code is thereby divided into a regular imagined arrangement of code fields, which at least in pairs are grouped into code groups. Thereby, within a code group, only a single code field is provided with a code element. A code group can consist of at least two or more code fields. The number of code fields, which are grouped together into a code group, can be arbitrarily large. The individual code fields are typically formed in a rectangular or square manner. They typically form a type of grid or a type of raster, which extends over the complete surface area of the code. The feature, according to which the code is subdivided into a regular, imagined arrangement of code fields grouped together at least in pairs into code groups, wherein only a single code field within a code group is provided with a code element, is to be understood in that the grid points of a regular gird in each case include a code element or do not include a code element, wherein the grid points are grouped into groups of grid points, which are adjacent to one another, and wherein each of these groups includes precisely one code element. Alternatively, it is moreover also conceivable not to provide exactly one code element per group, but very generally a fixed number of code elements per group of code fields or of grid points. Thus, for example, in each case always exactly two code fields within a group of four code fields can be provided with a code element in each case.

Attaching the code on the base of the capsule, and not on a cover, or, as described in the state of the art cited above, on a cover membrane, has various advantages. The capsule cover is therefore available for a decorative print, for information, which can be read by the user, or the like, and the fashioning of the cover is not compromised by an additional code. However, supplementarily or alternatively to a printing of the capsule cover, one also does not rule out the base of the capsule beaker including further visually recognisable information additionally to the code, for example decorative elements, a characterisation or other information in a suitable form, which can be read out. In particular, the code can also be suitably integrated into a decorative element for example.

Moreover, due to the incorporation of the code on the base, a detection unit in a horizontal brewing machine can be arranged ahead of the brewing chamber, i.e. upstream of the brewing chamber, where there is less danger of contamination due to the splashing of drinks or the like, and the installation space is less critical.

The grouping or bringing-together of several code fields into a code group is advantageously homogenous and uniform over the entire surface of the code. In particular, one can envisage all code fields of the code being subdivided into code groups, which with regard to the surface area are equally large and are non-overlapping and continuous. In particular, one envisages the individual code groups of the code lying next to one another in the surface of the base of the capsule beaker in a gapless manner. Typically, each code group has an identical geometry and an identical number of continuous code fields.

A homogeneous distribution results over the entire surface of the two-dimensional code, which is to say a homogenous surface density of code elements results over the surface of the code, in as much as the evaluation of the density is effected on the basis of the raster of the code groups, due to the fact that each code group is provided with exactly one code element, or alternatively, very generally with a fixed number of code elements. A homogeneous surface density of code elements on the base of the capsule beaker is advantageous for the attachment (depositing) of the code. The code, which can be lasered onto or lasered into the base by way of laser radiation, specifically can be written at a constant speed.

Moreover, a uniform or homogeneous distribution of code elements over the surface of the code is advantageous for an integrity test of the code, as well as for a redundancy of the code information stored in the code. Even before the actual decoding or decrypting of the code, already on the picture level one can determine whether it is the case of a designated code of a capsule envisaged for the brewing machine or, for example, the case of a product counterfeit, by way of simple means of a picture recognition and picture evaluation, which are simple and inexpensive to realise. The occupancy of only a single code field within a code group, or very generally of a fixed number of code fields within a code group, inasmuch as this is concerned represents a first test criterion for an integrity test. If, for example, several code elements are located within a code group or, for example, several code groups without a single code element are present, then this is at least an indication that with regard to the capsule, it is not a capsule envisaged for the brewing machine, or that the code or the imaging optics of the detection unit of the brewing machine is contaminated which is to say dirtied.

The described test criterion can already be effected on the picture level, which is to say without any decoding of information or of individual information bits. Inasmuch as this is concerned, only an extremely low computation power is necessary for the first integrity test. Moreover, the result of this first integrity test is already available after a relative short time, so that the integrity test, which is to say the code recognition and the code evaluation, leads to hardly any delays in the designated operation of the brewing machine, even whilst using comparatively inexpensive and low-capability hardware and software.

The first integrity test for determining the number of code elements within a code group can be implemented completely on the picture level of an imaging of the code. Moreover, it is also conceivable to completely make do without an integrity test on the bit level, which is to say after or during the read-out of code information. Inasmuch as this is concerned, one can make do without the use of so-called test bits within the code or code information, so that the information density of the code and the total quantity of code information stored in the code can be increased given a constant two-dimensional extension of the code.

The subdivision of the code into code fields and the assignment of code fields in code groups are moreover advantageous for the redundancy characteristics of the code. In particular, the code information can also be uniformly distributed over the surface of the code due to the uniform or homogeneous distribution of code information over the multitude of code groups. Due to the redundant deposition of code information, which is to say a multiple deposition of the code information over the surface of the code, one is able to succeed in local contamination of the code or local imaging errors of the code at any locations of the code being able to be tolerated, and the reading-out of the code information remaining uncompromised.

According to a further embodiment, one envisages the local position of a code element within the code group containing information. The shaping and the geometry of the code elements can be essentially identical for all code elements or at least for a part-quantity of the code elements. It is therefore not necessary to detect the shaping and the geometry of individual code element, for correctly reading out the code. It is merely the position of the code element within the code group that is assigned to information content.

Very generally, the code elements can be identical with regard to their shaping and dimensioning, or however can also systematically or non-systematically differ from one another. What is merely necessary is that they are recognisable as code elements, for example by way of them having at least one certain, defined characteristic (minimum area, base shape and alignment, etc.).

The subdivision of the code into code fields and code groups is unambiguously specified for each code. In a simplest embodiment, a code group includes two code fields lying next to one another. If the code element is located in the first code field then this, for example, corresponds to a zero bit, and if the single code element is located in the second code field, this can correspond to a one bit. A code group consisting of two code fields can therefore store and represent information of one byte.

According to a further development, a code group can include at least four code fields. Advantageously, one further envisages a code group including at least an even number of code fields. A code group, for example, can also include six, eight, ten or twelve or more code fields or consist of these. A code group that is formed from four code fields has an information content of 2 bits, and a code group formed from eight code fields has an information content of 3 bits (2³).

The code groups are typically designed in a square or rectangular manner. Inasmuch as this is concerned, they each include a regular arrangement of individual code fields, which lie next to one another. For example, a code group formed from four code fields can have a square geometry with two code fields lying next to one another and two code fields lying above one another. Moreover, with a code group of four code fields, it is conceivable to form a row or a column with four code fields which lie next to one another or below one another, the row then corresponding to the code group in each case.

The regular subdivision of the code into code fields and the occupancy of a code group formed from code fields, in each case by only a single code element lead to the respective code, with regard to the subdivision into code groups, having a homogeneous density of code elements over the surface of the code. Inasmuch is this is concerned, the presence of a homogeneous information density can represent a plausibility or test criterion already on a picture level of the code, by way of which criterion read errors are recognised, the errors e.g. being able to be caused by way of contamination and can be erroneously interpreted by the detection unit and/or a subsequently connected control as code elements. The position of individual or several code elements amongst one another can also represent a test criterion or plausibility criterion, in the same way and manner.

According to a further embodiment, several code groups and/or code fields are brought together into a code word. The number of code groups and code fields in a code word can be selected in an arbitrary manner. Typically, each code word has an identical number of code elements, which is to say an identical number of code groups. For the division into code words, one can envisage each code word consisting of an integer number of code groups. Moreover, it is conceivable for a code word to include, for example, one or more code groups as well as individual code fields. In particular, a code word can have an odd multiple of code fields.

In particular, it is conceivable for example for 1.5 code groups to be brought together into a code word. If the code groups for example include four code fields in each case, then a code word can consist for example of six code fields, of which four code fields are brought together into a code group, wherein the remaining two code fields belong to a further code group, which lies only partly within the code word. Hereby, in particular one can envisage one or more code groups contained completely in the code word functioning as carriers of the code or encrypted information, whereas individual code fields of the code word, which lie outside the respective code groups provide one or more test bits, by way of which an integrity test of the code can also be carried out on the bit level.

A further integrity test of the code can be effected with stipulation that each code word includes an identical number of code elements. The position of code words, code groups and code fields relative to the visually recognisable code elements of the code can also be determined by way of this test criterion, which is to be carried out on the picture level.

In particular, several plausibility and/or quality tests can be implemented on different code levels. It is conceivable for a first test to be effected with regard to a defined geometric shape of individual code elements. If, for example a code element having a geometric structure differing from a predefined, for example L-shaped geometry is read out, then already this can led to a rejection or a correct recognition of the code.

The implementation of a further test criterion or quality criterion is also possible on a further, for example second code level. For example here, on the picture level, one can directly examine whether an envisaged number of code element is located within a predefined surface segment of the plane. Thus, e.g., an integrity test can be carried out at the level of each or individual code groups or code fields. E.g., one can examine whether a code group includes precisely one code element in each case. The test criterion is not fulfilled if several or less than one code element is present per code group. To the same extent, this can then serve for the correct recognition of the code or one which is to be corrected.

According to a further embodiment, the code information which is stored in the code is redundantly contained in several code words, which is to say redundantly in the code. The redundant and multiple deposition of code information in the code and a surfaced distribution of the code information in the code render the decoding of the code extremely robust with regard to external negative influences and errors. Inasmuch as this is concerned, it is sufficient if only part-regions or a single part-region of the code can be visually read out and accordingly decoded, for reading out and decoding the actual code information.

The code information typically includes information concerning a special brewing program, for example a predefined number of a brewing program. The code information, however, can also include further information concerning the brewing procedure in detail, such as for example a brewing temperature, a brewing pressure, a brewing time as well as brewing quantity or water quantity and/or pre-infusion time. Such information can be represented as a sequence of individual bits. The conversion of the information to be stored in the code, into an information bit sequence is effected according to a predefined procedure. This, for example, can be stored in a conversion table. A sequence of information bits can moreover be extended by a certain number of test bits.

This can be effected with the help of a predefined algorithm, depending on the coded information. The additional test bits can be used for integrity testing the information contained in the information bits. The test bits can be computed at any time from a given bit sequence of information. If these agree with the test bits, which have been determined from a further bit sequence, for example, from a further code word, it is then to be assumed that the associated information, which is to say the bit sequence representing the information, is correct. An error is present if the test bits of different code words are different.

Finally, it is also conceivable to also carry out a plausibility test on the level of individual or several code words. Thus, in particular individual test bits contained in code words can be selectively read and evaluated for the plausibility control. A complete decoding of the code is not necessary for all plausibility or quality tests, which have been described above.

Basically, only a certain number of code fields, code groups or code words need to be able to be read out for a decoding. The plausibility tests and quality assessments of code elements, code fields, code groups and code words can then be used, in order to make a good selection, and the reliability of the available information can be included in the decoding process on decoding. In particular, all decoding possibilities resulting in a given situation can be compared to one another. A decision concerning the coded content can then be made with a certain probability or trustworthiness by way of the quality assessment of the respectively determined decoding possibilities.

Moreover, the quality of the code, i.e., its recognisability, can be determined several times and thus to a quite reliable extent, due to the possibility of a code testing or quality determining on the level of the code elements, on the level of the code fields or code groups and/or on the level of the code words. In particular, the quality of the code recognition can be assessed on each of these levels.

Independently of this, it is generally conceivable for an assessment of the quality of recoded code on the picture level to be included in the computation of a grid as well as in the computation of one or more grid constants forming the basis of the code.

Thus, for the code recognition, in particular one can envisage a grid or a grid constant of the code being determined by approximation, in particular by way of so-called fitting, in order to carry out a scaling of the recorded code inasmuch as this is concerned. The quality of the code, which is determined on the picture level can be used for this scaling, but also for the positioning of a grid. The decoding of the code itself can be effected or simplified by way of the quality recognition. Since the code is contained redundantly and several times, for example in each code word, then on the basis of a quality determining of all code words, those words, which amongst all code words have the highest quality or highest assessment, are selected for decoding the code. Decoding errors can be minimised to a high degree in this way and manner.

Should the decoding on the basis of those words with the highest quality assessment not be possible, or not provide a plausible result, one then envisages changing the grid constant and/or the grid position and carrying out the assessment and decoding afresh.

According to a further embodiment, one envisages at least the first code elements of the first code in each case including information, from which one of several possible alignments of the code in the plane of the base can be unambiguously derived. The code elements themselves typically have a two-dimensional design and have such a geometric contour that permits the alignment or orientation of the code elements in the plane of the base to be determined. The alignment of individual first code elements hereby correlates to the alignment of the first code formed by the code elements. One or more possible alignments of the code can be determined in a reliable and unambiguous manner on the basis of a determining of the orientation of an arbitrary code element, due to the fact that preferably each code element has a defined alignment to the alignment of the code. The information concerning the orientation of the code, in particular can be contained in each code element, so that it is at least the alignment of the code that can be recognised without further ado, independently of the actual reading-out and decoding.

A capsule of the known type can be inserted or introduced into the brewing machine in four different positions due to its symmetry and its square cross section. There are therefore four orientations for the capsule, each rotated by 90°, and thus also for the code, which is present on the base of the capsule. One of several possible orientations of the code can be unambiguously determined already by way of the recognition and identification of an individual and arbitrary code element, due to the fact that the individual code elements carry information concerning the orientation of the code. The orientation of the code can therefore be determined in a robust manner via a majority decision on the basis of all determined orientations of the code elements. If the arrangement of the code elements is selected in a manner such that they are located on an imagined grid structure forming the basis of the code, then the grid parameters can moreover be reconstructed by means of an arbitrary selection of code elements. The use of so-called called finder patterns for a 2D code thus not only becomes superfluous, but moreover the disadvantages, which are described above and which arise from a dirtied (contaminated) finder pattern, are advantageously avoided.

The use of finder patterns can be completely done away with due to the fact that the code elements provide coded information by way of their shape, their alignment in the plane and their surfaced distribution in the plane. The robustness of the code, in particular with regard to local contamination can be improved inasmuch as this is concerned.

In embodiments and with regard to the code elements, it is particularly the case that they do not have or define a rotationally symmetrical geometric structure, but rather an unambiguous, in each case imagined pointer structure, which is unambiguous, at least for the several possible alignments of the code in the brewing machine, i.e., for different alignments in the plane of the base.

The information for the code orientation and which is required for a decoding and reading-out of the code can be decoupled from the decoding of the code and be determined independently of this, due to the coupling of the code alignment with the alignment of its individual code elements, which is envisaged here. This can have an advantageous effect on the realisation of as low and as inexpensive as possible technical demands on the optical detection unit and on a subsequently connected picture evaluation.

The determining of one of several possible alignments of the code relative to a detection unit of the brewing machine can be effected on the basis of at least one code elements and its alignment in the plane of the base or its alignment in a picture plane of a detection unit. The determining of the alignment of the code is thus independent of the arrangement of several code elements relative to one another.

In particular, in these embodiments, the alignment of the code in the plane of the base is contained in each code element, so that the information concerning the alignment and orientation of the capsule relative to the detection unit of the brewing machine is redundantly contained in the code. This also applies to the grid parameters forming the basis of the code. These are also redundantly coded over the complete surface.

According to a further embodiment of the capsule, the first code includes a number of essentially identical and essentially identically aligned first code elements. In particular, it is conceivable for the first code to consist exclusively of identical code elements. Moreover, it is conceivable for the first code to consist of identical code elements, which are moreover also aligned identically to one another. Code information in particular can be contained in the spatial and two-dimensional, distributed arrangement of individual code elements. The provision of identical as well as identically aligned first code elements is not only advantageous for the unambiguous determining of the alignment of the code in the plane of the base, as has already been described, but also for an as precise and error-free as possible optical reading-out of the code itself

The detection unit of the brewing machine in particular is provided with an imaging, two-dimensional detector, for example with a camera. The use of exclusively identical and identically aligned first code elements permits the realisation of a particularly inexpensive detection unit. Under certain circumstances, it is only a regionally focussed and precise imaging of the code, for example of a central region of the two-dimensional code, which is necessary for a reading-out and decoding of the code. Inasmuch as this is concerned, it can already be sufficient for outer-lying edge regions of the code to be detected or imaged in the detection unit with a reduced focussing/sharpness than the middle region of the code, for reading out and decoding the code.

Since it is only the position of individual code elements within the plane of the base and/or within edge regions of the code, which is decisive for extracting code information, code elements imaged on the detection unit only in a comparatively unfocussed manner can already be sufficient for an error-free detection, reading-out and/or decoding of the code. This robustness with regard to blurring or optical errors on reading out, which is entailed by the inventive design of the code, also has the effect of a robustness with regard to variations of the code elements amongst one another. For example, it is not necessary for the code elements to be identical, i.e. it is not a necessity for all code elements to have the same size, the same colouring, the same alignment, etc.

According to a further embodiment, the first code elements include at least two straight line sections that are adjacent to one another at a defined angle. Straight-lined line sections of the code elements can be detected particularly precisely and simply in the detection unit. The detection unit in particular includes a two-dimensional, regular arrangement of optical or light-sensitive (sensitive to the visible, infrared and/or ultraviolet part of the electromagnetic spectrum) sensors, which are typically to be indicted as detector pixels.

Line sections of the code elements, which run in a straight line, can be imaged in accordance with the geometrical arrangement of adjacent detector pixels of the detection unit in this way and manner. In this way and manner, even with a low number of detector pixels, it is at least the alignment of the line sections of the code elements that can be precisely detected for the purpose of determining their alignment, but also the position of individual code elements within the 2-D code can be precisely detected, by way of a detection unit having only a comparatively low resolution.

According to a further development of this, one further envisages at least one line section of the first code elements running essentially parallel to the outer edges of the essentially rectangular or square code. The outer edges of the code can, but do not necessarily need to be designed in a manner in which they are optically or visually recognisable on the base of the capsule beaker. Moreover, it is conceivable for individual, outer-lying code elements to quasi virtually mark the outer edges of the rectangular or square code solely by way of their edge position. The parallel alignment at least of a line section to the outer edges of the code leads to a clearly recognisable code structure. In particular possible, slight deviations from the several possible alignments of the code or capsule, which are defined by the brewing machine, the deviations lying within a certain tolerance region, can be recognised by way of visually or optically recognisable outer edges and can be used for the numeric compensation of errors or for picture evaluation.

A parallel alignment of line sections or of code elements relative to the edge of the code is not absolutely necessary for the recognition of the code structure. The code structure can also be contained exclusively in the position of the code elements. Arbitrary, orientatable code elements, which can also be different in shape and size, can be used.

According to a further embodiment, at least one line section of the first code elements runs essentially parallel to the outer edges of the square base. Thereby, in particular one envisages the outer edges of the code also running parallel to the outer edges of the square base. One can moreover envisage the possible alignments of the code in the plane of the base and/or the typically four conceivable alignments of the capsule in the brewing machine coinciding with vertically or horizontally running outer edges of the square base, which is to say horizontally or vertically running outer edges of the rectangular or square code. The detection unit and the picture evaluation, which is integrated into this or subsequently connected to this, inasmuch as this is concerned can be provided with one or two preferential directions (x, y), which run parallel to the outer edges of the square base, which is to say parallel to the outer edges of the rectangular or square code provided on the base.

Moreover, it is conceivable for at least the first code elements to consist exclusively of line sections that all run parallel to the outer edges of the code.

According to a further embodiment, the first code elements are designed in an essentially L-shaped manner. An L-shaped design of code elements includes two line sections, which are adjacent to one another roughly at an right angle and which are both designed in a straight-lined manner and can have essentially the same or different lengths.

One end of a first line section is hereby adjacent to an end of the second line section. Oppositely lying ends of the line sections are thereby spaced from one another. The intersection point of the line sections can, for example, define a reference point of the respective code element, whereas one of the two line sections can function as a pointer structure. Hereby, it is conceivable for the line sections to have the same or different lengths. A straight-lined pointer, departing from the intersection point of the two line sections, for example, can coincide with one of the line sections of the code element and in this way and manner unambiguously determine the alignment of the respective code element and with this, of the complete code, in the plane of the base. An unambiguous orientation of the respective code element can be derived from the relative position and alignment of the two line sections to one another in the case line sections, which are designed of roughly equal length.

According to a further embodiment, which is an alternative to this, it is moreover conceivable for the first code elements to include at least one arch section. A multitude of different code elements can be considered, apart from L-shaped code elements. Code elements with at least one arch section, for example, can have a C-shaped or U-shaped geometry. Apart from L-shaped code elements, it is also particularly T-shaped or V-shaped code elements are also conceivable, and these are characterised by a particularly simple geometric structure, so that the determining of an alignment of individual code elements can be effected in a reliable and precise manner, even with the use of a detection unit with a low resolution.

It is particularly, it is those code elements, which consist exclusively of line sections running parallel to the code edges, which permit an extensive reduction of the demanded resolution of a detection unit. In particular, an L-shaped code element is characterised by a minimal number of pixels for a detection. An L-shaped code element moreover displays a good behaviour with respect to blurring, on picture recognition and evaluation.

According to a further embodiment, the code elements are lasered onto the base of the capsule beaker or lasered into the base. The deposition of the code elements, consequently of the complete code onto the outer side of the base or into the material of the base is effected by way of laser radiation. Hereby, in particular one can envisage the material of the base undergoing a colour change or texture change when being subjected to laser radiation at a certain defined wavelength region, so that the code elements, which are formed by way of this, can be visually represented in a particularly high-contrast manner. Thereby, it does not necessarily need to be the case of a colour change that is visible to the human eye. It is also conceivable for a change in the reflection characteristics and/or absorption characteristics concerning IR or UV radiation to be achieved by the laser, so that a code, which cannot be recognised by the naked eye, but by a detection unit using IR-light or UV light arises. It is further conceivable for the code elements to be realised as laser engraving on or in the base of the capsule beaker. For this reason, no printing methods or an attachment of print dyes, which such a method entails are necessary for the attachment of the code elements and of the code, on the base of the capsule beaker. The lasering of the code elements onto or into the base of the capsule beaker effects a particularly durable and robust coding of the capsule beaker and thus of the complete capsule.

According to a further embodiment, one envisages the first code including 50 to 400 individual code elements and preferably 70 to 100 individual code elements, wherein these code elements are arranged two-dimensionally and spatially distributed on the base of the capsule beaker. The individual code elements in particular are arranged to one another without any overlapping. Inasmuch as this is concerned, they are provided on the base of the capsule beaker in manner distanced to one another. In total 100 to 800 bits of information can be integrated into the base of the capsule beaker by way of the mentioned number of code elements. Hereby, in particular, one envisages a code element having an information content of 2 bits in each case. In particular, the information content of each and every code element is contained in the spatial position of the code element in the plane of the base.

According to a further embodiment, one further envisages the capsules including at least one second optically readable code on the base of the capsule beaker, additionally to the first optically readable code. As already is the case with the first code, the second visually recognisable code also includes a two-dimensional arrangement of several second code elements, which with respect to a middle point of the first code lie radially outside the first code. In particular, for the first code one envisages it extending over the middle point of the base of the capsule beaker. The middle point of the first code can thereby roughly coincide with a geometric middle point of the base of the capsule beaker.

The first and the second code thereby represent different code levels. The code, which is deposited on the capsule base, in particular can be designed in a two-staged or multi-staged manner, wherein the first code defines a first code stage or a first code level, and wherein the second code defines a second code stage or a second code level.

If one considers the, for example, four different possible alignments of the code, which is to say of the capsule within the brewing machine, then the middle point of the first code in particular can coincide with a rotation axis of the capsule beaker, with respect to which axis an alignment of the capsule can be brought into another conceivable alignment within the brewing machine.

More and different information can be stored in a coded manner on the base of the capsule beaker and read out, in a graduated manner due to the provision of a second code with second code elements. The second code in particular can be optionally provided and contain optional information, which is possibly not of any significance with regard to the operation or the brewing procedure of the brewing machine and is only of a lesser significance. In particular, it is conceivable for information relevant to the brewing machine and/or relevant to the brewing procedure such as for example a water quantity, water temperature, brewing time, extraction pressure or pre-infusion time to be contained in the first code.

Moreover, it is conceivable for the first code to include information such as, for example, a capsule identification or a brewing or extraction program, which is envisaged for the capsule. The second code can include information such as the sell-by date, a location of manufacture or origin, a manufacturing date or also a batch number.

The arrangement of the first and of the second code in a manner spatially separated from one another permits a selective reading-out of the first and second codes. The spatially separated arrangement of different codes, which is graduated radially outwards, can moreover be used for different brewing machines. The second code can be used or ignored, depending on the design of the brewing machine. Optional additional information concerning the capsule and its extraction material can be rendered accessible, for example, via the second code, only to a certain type or design variant of brewing machines. This can encourage the end-consumer to purchase such machines.

In contrast, it can be sufficient to only read out the first code, for particularly inexpensive brewing machines. Inasmuch as this is concerned, such machines can also be provided with an accordingly minimised detection unit and picture evaluation, which merely visually detect or decode the first code located in the central region of the base of the capsule beaker.

According to a further embodiment, the first and the second code elements of the first and second code are essentially identical. The first code elements however are thereby aligned differently, compared to the second code elements. For example, the first code elements can be aligned relative to the second code elements in a manner rotated by 90°, by 180° or by 270°, in the plane of the base of the capsule beaker. Here too, all first code elements are advantageously identical and identically aligned to one another. The same can also apply to the second code elements of the second code.

Moreover, all of the previously described characteristics and features of the first code elements can be identical or essentially identical to those of the second code elements or also correspondingly realised for the second code elements.

According to a further aspect, the invention moreover relates to a system for preparing a drink from a previously described capsule. The system includes a brewing machine with a brewing chamber for receiving a capsule of the above mentioned type, the capsule having an essentially square base, for the purpose of preparing a brewed drink, as well as with an optical detection unit for reading out a first code from the base of the capsule beaker whilst the capsule is located in a read position above the brewing chamber. The detection unit and/or the picture evaluation subsequently connected to it is hereby designed in a manner such that it subdivides the first code into a regular imagined arrangement of code fields and groups these together at least in a paired manner into code groups. The detection unit and/or the picture evaluation determines a number of code elements per code group, for testing the integrity of the code. The detection unit and/or the picture evaluation hereby carries out an integrity test directly on the picture level. Exactly one code element should be located in each code group. At least one corresponding capsule with a square base carrying the first code also belongs to the system, with which the mentioned identity test confirms the design of the recognised code as a code with a two-dimensional arrangement of several code elements, with which the first code is subdivided into a regular, imagined arrangement of code fields, which are grouped together at least in pairs into code groups, and with which only a single code field within a code group is provided with a code element.

A picture evaluation resulting in part-regions of the capsule base being rejected as not belonging to the code because they do not fulfil the criteria of the identity test is thereby not ruled out, even if they contain picture information that could otherwise be considered as code information, for example by way of them being able to be considered as a code group with several code elements. Such regions for example can be arranged peripherally or also be within outer edges of the valid code.

If however a number of code groups including several code elements or no code elements at all lies above a predefined threshold value, then this is an indication that it is a case of a capsule which is not envisaged for the brewing machine concerned.

According to a further aspect, the invention moreover relates to a method for identifying a capsule with a capsule beaker having an essentially square base and with a code with a two-dimensional arrangement of several code elements on the base, in a brewing machine for preparing a drink. The method hereby includes the following steps:
transferring the capsule inserted into the brewing machine by the user, into a read position,
subdividing the code on the base of the capsule beaker into a regular imagined arrangement of code fields and at least a paired grouping of at least two code fields into a code group in each case,
carrying out an integrity test of the code by way of determining a number of code elements in each code group and selecting code groups with which only a single code field within a code group is provided with a code element, and
decoding the code and identifying the capsule type on the basis of the information contained in the code.

Capsule counterfeits or imitations can be identified by way of a faulty or non-existent code in this way and manner, and suitable countermeasures can be initiated. If, for example, a capsule with a faulty or absent code is recognised, then a further transport of the capsule into the brewing chamber can be prevented, which is to say a brewing procedure can be interrupted or blocked. On recognising a code, the code information can be used for the control of the brewing machine, in particular of the brewing procedure.

It is generally the case that all features and advantages, which are described in the context of the capsule, apply to the same extent to the system and to the method described here, and vice versa.

The term essentially identical or essentially identically aligned code elements, which is demanded in embodiments of the invention, is to express the fact that the code elements within the scope of the resolution accuracy of the detection unit and the subsequently connected picture evaluation are provided on the capsule base in a respectively identical and identically aligned manner. The detection unit and subsequently connected picture evaluation can provide a certain error tolerance, so that even slight, but also larger deviations from a defined geometry, position and/or defined alignment of the code elements can still be reliably detected.

Geometric deviations of the code elements with regard to their longitudinal or transverse extension of up to 10% or up to 20%, up to 30% or even up to 40% should hereby still fall within the tolerance region of the detection unit and thus still be valid as being essentially identical. In contrast, line or stripe thicknesses can differ from a predefined thickness by up to 200%. With regard to the alignment, deviations of 5%, up to 20°, 30° or even 35% can be tolerated which is to say can be compensated by the detection unit and the subsequently connected picture evaluation.

### BRIEF DESCRIPTION OF THE DRAWINGS

Embodiment examples of the invention are hereinafter described by way of figures. In the figures, the same reference numerals indicate the same or analogous elements. There are shown in:

FIG. 1 is a perspective view of a capsule for drinks preparation,

FIG. 2 is a lateral view of the capsule according FIG. 1,

FIG. 3 is a schematic representation of a brewing machine, which is designed for receiving a capsule,

FIG. 4 is a schematic and simplified representation of a detection unit, which is provided in the machine and is for visually detecting the code on the base of the capsule beaker,

FIG. 5 is a schematic representation of a first code, which is provided on the base of the capsule beaker,

FIG. 6 is a simplified and schematic representation of a regular subdivision of the first code into individual code fields, code groups and code words,

FIG. 7 shows different positions of a code element in different code fields of a code group,

FIG. 8 is a simplified schematic representation of a base of the capsule beaker with a first and with a second code, and

FIG. 9 is a schematic representation of two different code elements.

### DETAILED DESCRIPTION OF THE INVENTION

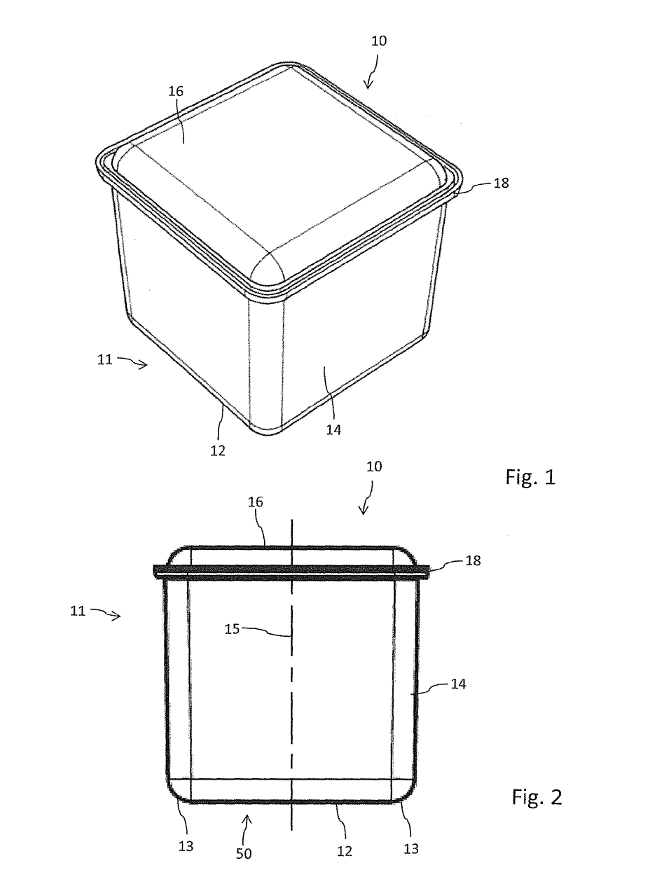

The capsule 10, which is represented in FIGS. 1 and 2, includes a pot-like capsule beaker 11 with a square capsule base 12. The capsule beaker 11 is, away from the base 12, closed with a capsule cover 16 extending over the complete cross section of the capsule beaker 11. The capsule cover 16 and the side walls 14 of the capsule beaker 11 form an outwardly projecting flange section 18. The peripheral flange section 18 apart from a closure function, serves for mechanically coding the capsule. A receiver 21, which is provided on a brewing machine 20 and is typically in the form of an insertion or receiving shaft, can have a geometry corresponding to the outer contour of the capsule 10, which is represented in a lateral view in FIG. 2, so that the capsule can be introduced into the receiver of the brewing machine 20, compellingly in an orientation or alignment, in which the base 12 of the capsule beaker faces a detection unit 24.

Given a correct positioning of the capsule 10 in a read position L within the brewing machine 20, there are still four different possible orientations of the capsule 10 and of the optically readable, which is to say visually recognisable code 50 provided on the base 12, due to the square geometry of the base 12 of the capsule beaker 11 and of the essentially square, peripheral flange section. The different and several possible alignments of the code 50 are due to rotations of the capsule with respect to its imagined rotation axis 15, which extends essentially perpendicularly to the base 12 and perpendicularly to the capsule cover 16, and which in particular can coincide with a geometrical middle point of the base 12 and capsule cover 16.

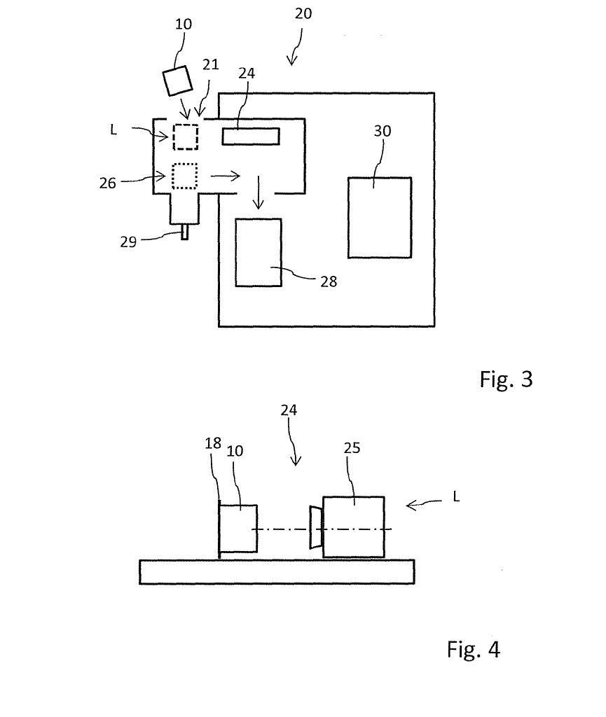

The brewing machine 20, which is shown in FIG. 3, is envisaged for receiving at least one capsule 10, which by way of insertion into the receiver 21 can firstly be held in a read position L. In this read position L, the code 50 provided on the outer side of the base 12 of the capsule beaker 11 can be visually detected by way of the detection unit 24 and fed to a picture evaluation, by way of which picture evaluation the coded information can be decoded. A brewing chamber 26, in which the capsule 10 filled with the extraction product is at least partially perforated and the extraction material can be subjected to a fluid envisaged for the extraction procedure, in particular hot water, is located after the read position L. The extract, which is to say the drink, prepared in this way and manner can subsequently be collected via an outlet 29, in a drinks vessel, which is not explicitly shown. The spent capsule 10 can then be fed to a capture container 28 after the brewing procedure, and this container needs to be emptied now and again.

The brewing machine 20 is moreover provided with a control 30, which in the one hand is coupled to the detection unit 24 and on the other hand to the brewing chamber 26. A picture evaluation can either be contained in the detection unit 24 or in the control 30. The brewing procedure can be controlled, however at the minimum can be influenced, by reading out the code information of the capsule 10. The code 50, for example, can contain information concerning a preset brewing program, which can be automatically selected by the control 30 by way of the mere visual recognition of the code 50. The operating comfort of the brewing machine 20 can be increased and improved in this manner.

Moreover, by way of the provision of a code on the capsule, one succeeds in only original capsules provided by the manufacturer for the brewing machine 20 being able to be subjected to a brewing process. Product counterfeits as well as capsules 10, which although having an outer geometry identical to that of the capsules shown in FIGS. 1 and 2, however do not have a code or a wrong code due to them not being envisaged for the brewing machine, can be recognised by the detection unit 24 or by the control 30, so that the initiation of the brewing process can be prevented.

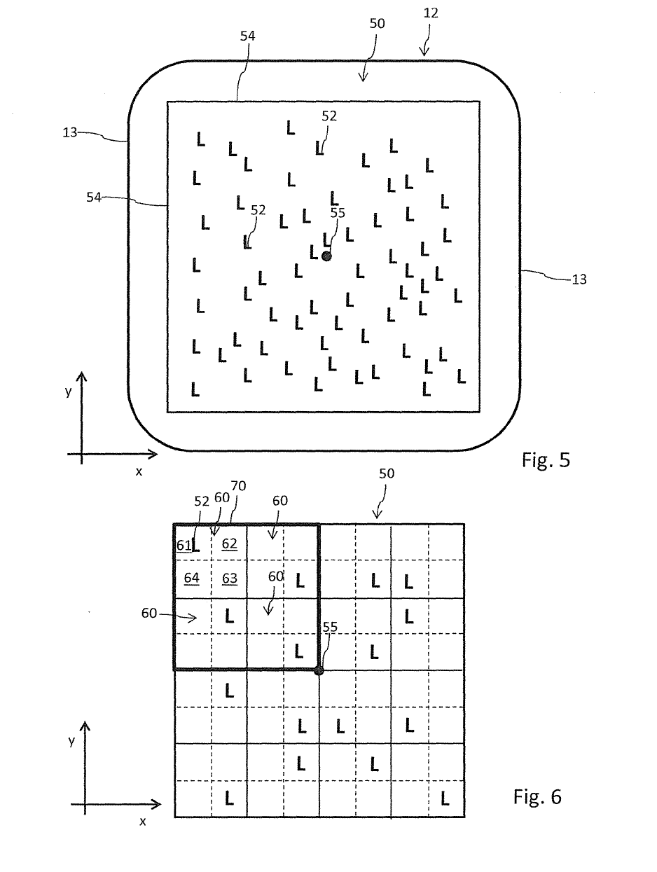

The detection unit 24 is represented in a simplified manner in the schematic representation according to FIG. 4. The detection unit 24 in particular includes a camera 25, which, with its optical axis typically and advantageously essentially coincides roughly with the middle point 55 of a first code 50 shown in FIGS. 5 and 6, as soon as the capsule 10 is located in the read position L within the brewing machine 20. A first code 50 on the base 12 of the capsule beaker 11 is represented schematically in FIG. 5. The first code 50 has an at least imagined middle point 55, which lies centrically, which is to say centrally within the outer edges 54 of the first code 50.

The first code 50 moreover includes a two-dimensional arrangement of several first code elements 52. Each of the first code elements 52 contains information, from which one of several possible alignments of the code 50 in the plane of the base 12 is unambiguously derivable. The code 50 can be arranged in total in four different alignments, in the X-Y plane, which is represented in FIGS. 5 and 6 and which, for example, represents the picture plane of the detection unit 24 or coincides with this. The individual alignments can be assumed, for example, by way of a rotation of the capsule 10 in each case by 90° with respect to its rotation axis 15. The rotation axis 15 of the capsule beaker 11 can thereby coincide with the imagined middle point 55 of the first code 50.

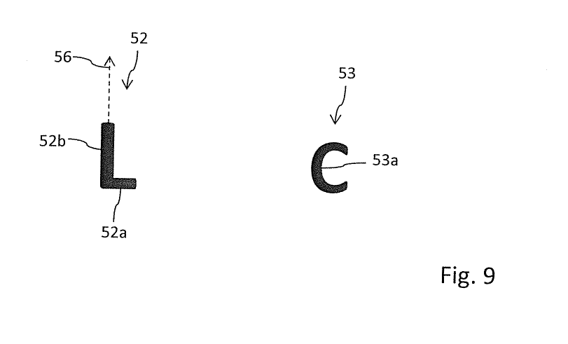

What can be recognised is that all first code elements 52 of the first code 50 are designed in an identical or essentially identical manner. They have an L-shaped contour with a first line section 52a, which extends horizontally in FIG. 5 and FIG. 9 and with a second, essentially vertically aligned line section 52b. With the alignment of the code 50 and of its individual code elements 52, which is represented in FIGS. 5 and 9, the intersection point of the line sections 52a, 52b lies at the bottom left. A short limb or the first line section 52a extends from the intersection point horizontally to the right, whereas the longer, i.e. the second line section 52b extends from the intersection point of the line sections 52a, 52b vertically upwards.

This arrangement and alignment of the individual line sections 52a 52b renders possible an unambiguous determining of the alignment of the associated code element 52 and of the code 50, which is formed by this. In particular, a pointer structure 56 can be unambiguously assigned to the code element 52. Here, for example a pointer structure 56 in the extension of the second line section 52b is shown in FIG. 9, wherein the pointer structure 56 points away from the intersection point of the two line sections 52a, 52b. On rotating the code 50 and its code elements 52, for example by 90° in the clockwise direction, a corresponding rotation of the line sections 52a, 52b as well of the associated pointer structure 56 results. This would then point horizontally to the right. The alignment or the orientation of the code 50 in the plane of the base, between the several possible alignments, can be determined comparatively simply as well as with a reduced effort concerning software and hardware technology, by way of determining the alignment of a single arbitrary code element 52, due to the fact that all code elements 52 are aligned essentially identically to one another and by way of the orientation of the code elements 52 being fixedly linked to the orientation of the code 50.

Hereby, it is particularly advantageous if at least one line section 52a, 52b of the first code elements 52 runs essentially parallel to the outer edges 13 of the square base 12 and/or essentially parallel to the outer edges 54 of the essentially rectangular or square code 50. Moreover, a right-angled arrangement of the differently long line sections 52a, 52b has been found to be advantageous for a particularly robust and precise position recognition of the code elements 52. The detection unit 24 in particular can include a regular, two-dimensional arrangement of several detector pixels, which can be arranged horizontally next to one another and vertically below one another, corresponding to the X-Y plane. Even with a low resolution of the detection unit or even with imaging errors, a picture recognition, which is adequate for determining the alignment of the code 50, can still be provided, due to the fact that the line sections 52a, 52b of the first code elements 52 are either aligned vertically or horizontally with respect to the X-axis or Y-axis.

The use of L-shaped code elements 52 is only described by way of example and does not necessarily need to be provided. Basically, it is also conceivable to use other code elements 53, for example with a C-shaped basic geometry and with an arch section 53a, as is shown in FIG. 9. U-shaped, V-shaped or T-shaped code elements are conceivable to the same extent.

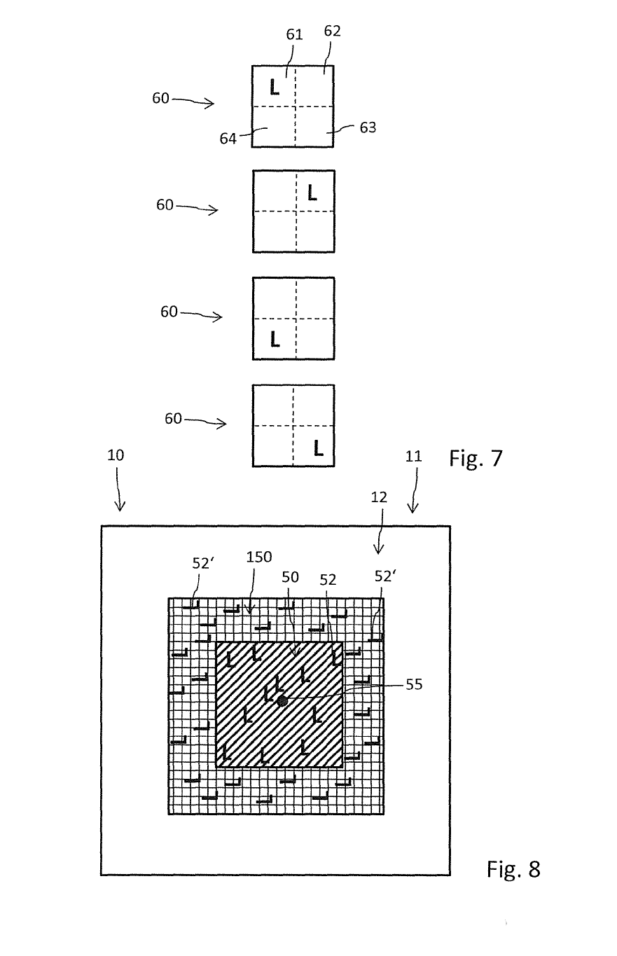

In FIG. 6, it is represented schematically as to how the first code 50 is subdivided into a regular imagined arrangement of code fields 61, 62, 63, 64, which at least in pairs are grouped into code groups 60. Hereby, only a single code field 61, 62, 63, 64 within a code group 60 is provided with a code element 52, whereas the remaining code fields 61, 62, 63, 64 of a code group 60 remain free of code elements 52. The different conceivable positions of a code element 52 in a code group 60, which is formed from in total four code fields 61, 62, 63, 64 are shown in FIG. 7. The four code groups 60, which are represented in FIG. 7, each represent one of four different conditions. Inasmuch as this is concerned, a code group 60, which is formed from in total four code fields, represents information of in total 2 bits (2²=4).

The rule, according to which each code group 60 is provided with only a single code element 52 has the effect that the surface density of first code elements 52 normalised onto the surface area size of the code groups 60, is constant over the entire surface of the first code 50. Moreover, each arbitrary surface segment of the first code 50 which has an integer number of code groups has an identical density of information. Finally, the local position of a code element within the code group is a carrier of the information concerned. The code information can be stored in the code by way of a single type of identical code elements 52, due to the fact that the code information is contained in the position of the individual code elements 52 relative to the code groups 60 or relative to the outer edge 54 of the code 50.

Moreover, one envisages a code group 60 including at least four code fields 61, 62, 63, 64 and, entailed by this, a minimum information with a 2 bit length. Moreover, several code groups 60 and/or several code fields 61, 62, 63, 64 can be grouped together into a code word 70. With the embodiment shown in FIG. 6, the code groups 60, which are provided in the left upper square of the code 50, are grouped together into a code word 70, which in total includes sixteen code fields 61, 62, 63, 64.

According to the requirement that a code group 60 is permitted to contain or include only a single code element 52, a first integrity test of the code 50 can be effected independently of a decoding of the code 50 and thus already directly on the basis of a recorded picture of the code 50. If, for example, the detection unit 24 recognises that more than one code element 52 is contained in several code fields 60, then this can directly be assessed as an indication that it is the case of a faulty or contaminated code 50 or of a counterfeit capsule. The number of code elements 52 within a code word 70 can be examined in the same way and manner.

Moreover, one envisages code information of the code 50 being redundantly contained in several code words 70. In this way and manner, it can be ensured that the code 50 and the code information contained in this can be read out in a reliable manner in the case of regional contamination in the region of the code 50 or of the detection unit 24. Thereby, in particular it is conceivable for the imaging and read-out quality of individual code words 70 to be determined, for example, by way of assigning and identifying individual code elements 52 to, and with, individual code words 70. If, for example, a demanded number of code elements 52 for the code word 70 should not be contained in a recorded picture, then this is an indication that the code word 70 concerned has been affected by contamination or is subject to an imaging error. Of the quantity of code words 70, it is typically only those which have a predefined number of code elements 52, which are selected for the decoding.

If not enough complete code words 70 are present for the decoding, then several estimations or assumptions to be considered can be made at the respective locations. Then, in the course of an integrity test of the code information subsequently resulting from the respective assumption, and/or of the individual information bits, after decoding, it can be decided whether the assumption was correct or not. Accordingly, a different assumption can also be made on the basis of the integrity test. This procedure can be repeated iteratively until the code information resulting from the made assumption fulfils the criteria of the integrity test.

Apart from the grouping of individual code groups 60, which is represented in FIG. 6, a code word 70 can basically also consist, for example, of one or more code groups and additionally of one or more code fields, so that the total number of code fields 61, 62, 63, 64 of a code word 70 is an odd numbered multiple of the number of code fields 61, 62, 63, 64 per code group 60. Hereby, it is conceivable for individual code fields 61, 62, 63, 64 to contain a type of test bit or test code, whereas the code words 70 carry the actual code information.

In the further embodiment of a capsule 10, according to the representation of FIG. 8, it is conceivable for not only a first code 50, but yet for a second code 150 to be provided on the base 12 of the capsule beaker 11, additionally to the first code 50. Whereas the first code 50 with its first code elements 52 is arranged roughly centrally or in a middle region of the base 12, the second code 150 with its second code elements 52′, with respect to the geometrical middle point of the first code 50 is arranged radially outside the first code 50. In the embodiment according to FIG. 8, the second code 150 completely encloses the first code 50 in the peripheral direction. The first and second code 50, 150 thereby each have a rectangular or square outer contour. In other words, the first code 50 is located within the second code 150.

The codes 50, 150, however, are not designed in an overlapping manner. There are solely first code elements 52 belonging to the first code that are located in the region of the inner lying first code 50. The second code elements 52′ can be designed identically to the first code elements 52′. In this case however, one then envisages the first and second code elements 52, 52′ being aligned differently for the unambiguous and improved differentiation of the first and second code 50, 150. Here, all first code elements 52 are aligned in an essentially identical manner, whereas all second code elements 52′ are aligned in an essentially identical manner. In the embodiment example shown in FIG. 8, the orientation of the second code elements 52′ is rotated in the anticlockwise direction by 90° in comparison to the orientation of the first code elements 52.

However, differing from this, it is conceivable for example for the second code elements 52′ to have a geometry, which is different to the L-shaped contour, for example a C-shaped contour or a U-shaped contour, which as such can be visually differentiated from the contour and geometry of the first code elements 52. For determining the alignment of the first and second code 50, 150, it is basically sufficient if only one of the first and second code elements 52, 52′ contains information, from which one of several possible alignments of the code 50, 150 in the plane of the base 12 can be unambiguously derived. Point-like or rotationally symmetrical code elements can basically also be used instead of rotated L-shaped second code elements 52′.

The first and second codes 50, 150 typically contain different code information. The first code 50 typically includes information provided for a brewing procedure, for example with regard to a brewing program, water quantity, brewing temperature, brewing pressure, brewing time or pre-infusion time, whereas the outer lying code 150, which is possibly only optionally to be used for certain brewing machines 20, contains further additional information concerning the extraction material, such as of example a sell-by-date, a production location, a location of origin or a batch number.

The different or the differently aligned code elements 52, 52′ permit a visual separation of the first and second code 50, 150, so that these can be detected, read out and decoded separately and independently of one another. The alignment of the second code elements 52′ relative to the outer edges 54 of the first code 50 or of the second code 150 as well as the arrangement of the second code elements 52′ amongst one another, in particular their arrangement in an at least imagined or virtual subdivision into code fields 61, 62, 63, 64, code groups 60 and code words 70 can be designed essentially identically as with the first code elements 52. The first code 50 as well as the second code 150 can be recognised, read out and decoded with one and the same picture evaluation in this way and manner.

The redundancy test here is selected in a manner such that the code information can be decoded already with a readability of 10% to 15% of the code surface. The code information is quasi uniformly distributed over the surface of the code 50 by way of the homogenous distribution of code groups 60 and code words 70 over the surface of the code 50. This renders the code 50 particularly robust given regional contamination or imaging errors

An integrity and plausibility test of code words 70 can be achieved directly on the bit level and on picture level due to the predefined constraint that a code group 60 formed from code fields 61, 62, 63, 64 includes exactly one code element 52. Moreover, a constant write time for the code 50 on the base 12 of the capsule beaker 11 can be achieved by the homogeneous distribution of code elements within code groups. On writing or inscribing the base 12, by way of laser for instance, it is always the same number of code elements 52 which are written per unit of time.

It is even conceivable to carry out an integrity test of the code 50 or of the code words 70 or code groups 60, which are contained in the code 50, purely on the picture level. The better the integrity test is effected on the picture level, the less test bits are to be added to the code words 70. It is even conceivable to carry out an integrity test of the code 50 completely on the picture level, so that one can largely make do without test bits within the code 50.

### LIST OF REFERENCE NUMERALS

10 capsule
11 capsule beaker
12 base
13 outer edge
14 side wall
15 rotation axis
16 capsule cover
18 flange section
20 brewing machine
21 receiver
22 brewing unit
24 detection unit
25 camera
26 brewing chamber
28 capture container
29 outlet
30 control
50 code
52 code element
52′ code element
52a line section
52b line section
53 code element
53a arch section
54 outer edge
55 middle point
56 pointer structure
60 code group
61 code field
62 code field
63 code field
64 code field
70 code word
150 code

1. A capsule for drinks preparation in a brewing machine, wherein the capsule comprises a capsule beaker that is filled with an extraction material and has an essentially square base, and a capsule cover closing the capsule beaker, wherein at least one first optically readable code is on the base of the capsule beaker, said code comprising a two-dimensional arrangement of several code elements, wherein a first code is subdivided into a regular, imagined arrangement of code fields, which at least in pairs are grouped into code groups, wherein only a single code field within a code group is provided with a code element.

2. The capsule according to claim 1, wherein the local position of the code element within the code group comprises information.

3. The capsule according to claim 1, wherein a code group comprises at least four code fields.

4. The capsule according to claim 1, wherein several code groups and/or code fields are brought together into a code word.

5. The capsule according to claim 4, wherein each code word comprises an identical number of code elements.

6. The capsule according to claim 4, wherein code information is redundantly contained in several code words.

7. The capsule according to claim 1, wherein each of the code elements in each case comprises information, from which one of several possible alignments of the code in a plane of the base can be unambiguously derived.

8. The capsule according to claim 1, wherein the first code comprises a number of essentially identical and essentially identically aligned first code elements.

9. The capsule according to claim 1, wherein the first code elements comprise at least two straight line sections that are adjacent one another at a predefined angle.

10. The capsule according to claim 9, wherein at least one line section of the first code element runs essentially parallel to the outer edges (54) of the essentially rectangular or square code and/or parallel to the outer edges of the square base.

11. The capsule according to claim 1, wherein the code elements are lasered onto the base of the capsule beaker or into the base.

12. The capsule according to claim 1, wherein the first word comprises 50-400 code elements.

13. The capsule according to claim 1, wherein at least one second optically readable code is on the base of the capsule beaker, said second optically readable code comprising a two-dimensional arrangement of several second code elements that are arranged radially outside the first code with respect to a middle of the first code.

14. The capsule according to claim 13, wherein the first code elements and the second code elements are identical and the first code elements are aligned differently compared to the second code elements.

15. A system for preparing a drink from capsule according to claim 1, comprising:
a brewing machine, comprising:
a brewing chamber for receiving a capsule with a capsule beaker with an essentially square base,
as well as an optical detection unit for reading out a first code with a two dimensional arrangement of several code elements on the base, while the capsule is located in a read position above the brewing chamber,
wherein the detection unit is designed in a manner such that it subdivides the first code into a regular imagined arrangement of code fields, groups these at least in pairs into code groups, and for testing the integrity of the code, determines a number of code elements in each code group and selects code groups, with which only a single code field within a code group is provided with a code element,
wherein the system moreover comprises a capsule with an essentially square base as well as with the first optically readable code on the base, with which the identity test results in several code groups with exactly one code field, which is provided with a code element.

16. A method for identifying a capsule with a capsule beaker with an essentially square base and with a code with a two-dimensional arrangement of several code elements on the base, in a brewing machine for preparing a drink, comprising the steps of:
transferring the capsule inserted into the brewing machine by a user, into a read position,
subdividing the code on the base of the capsule beaker into a regular imagined arrangement of code fields and at least a paired grouping of at least two code fields into a code group in each case,
carrying out an integrity test of the code by way of determining a number of code elements in each code group and selecting code groups with which only a single code field within a code group is provided with a code element and
decoding the code and identifying the capsule type on the basis of the information contained in the code.
